(19) United States
(12) Patent Application Publication
(10) Pub. No.: US 2025/0206661 A1
(43) Pub. Date: Jun. 26, 2025

(54) METHOD FOR PRODUCING CEMENT CLINKER

(71) Applicant: TOKUYAMA CORPORATION, Yamaguchi (JP)

(72) Inventors: Kenichi TSUJIO, Yamaguchi (JP); Ryota KAKIMOTO, Yamaguchi (JP); Takuya SEKI, Yamaguchi (JP); Kojiro MIYAZAKI, Yamaguchi (JP)

(73) Assignee: TOKUYAMA CORPORATION, Yamaguchi (JP)

(21) Appl. No.: 18/848,844

(22) PCT Filed: Mar. 9, 2023
(86) PCT No.: PCT/JP2023/008981

§ 371 Date: Sep. 19, 2024

(30) Foreign Application Priority Data
Mar. 28, 2022 (JP) 2022-052167

(51) Int. Cl. C04B 7/43; C04B 7/44; C04B 7/52; C04B 28/14

(52) U.S. Cl. CPC C04B 7/434; C04B 7/44; C04B 7/52; C04B 28/14

(57) ABSTRACT

A method for producing a cement clinker, that includes using fuel containing gas fuel as fuel of a precalcination burner in a precalcination furnace that precalcinates cement clinker powder raw material.

### TECHNICAL FIELD

The present invention relates to a method for producing a cement clinker.

### BACKGROUND ART

Steps when producing cement include mainly a raw material preparing step of drying and crushing a cement clinker raw material such as limestone, clay, etc., a calcination step of calcinating the prepared cement clinker powder raw material with a calcination apparatus such as a calcination kiln, to produce a cement clinker, and a finishing step of adding gypsum, etc. to the produced cement clinker to make a cement.

In the calcination step, before the main calcination by a calcination kiln, etc., it is common to precalcinate a cement clinker powder raw material preliminarily in a precalcination furnace.

In the calcination kiln, generally, carbon containing-thermal energy source such as petroleum, coal, etc. is used as a thermal source and there was a problem that a large amount of CO₂ is generated at the time of combustion.

Thus, for minifying the generation amount of CO₂ generation, it is proposed to use gas fuel with low CO₂ generation as main thermal energy source.

For example, a method of using hydrogen, methane, ethane, propane as gas fuel (see Patent Literature 1), or a method of using ammonia (see Patent Literature 2) is proposed.

### CITATION LIST

### Patent Literature

Patent Literature 1: Japanese Patent Laid-Open Publication No. 2018-052746
Patent Literature 2: Japanese Patent Laid-Open Publication No. 2019-137579

### SUMMARY OF INVENTION

### Technical Problem

Compared to when using carbon-containing thermal energy source such as petroleum, coal, etc., by using gas fuel such as hydrogen and methane, etc., the generation amount of CO₂ is decreased.

However, since the burning speed of gas fuel is faster as compared to carbon-containing thermal energy source such as petroleum, coal, etc., the temperature near the tip part of the kiln burner is increased and the temperature of the kiln burner may go over its heat resisting temperature, or even it does not, the heat damage (damage) of the kiln burner is significant, and the lifetime of exchanging the kiln burner becomes short. Generally, the calcination kiln is often maintained on an one year cycle, but the cycle becomes shorter, and when the operation is stopped for only exchanging the kiln burner besides usual maintenance, the operation is stopped for at least a few days, and the production efficiency becomes very bad.

The object of the present invention is to provide a method for producing a cement clinker that enables reducing the generation amount of CO₂, without affecting usual operation.

### Solution to Problem

As stated above, the present inventors have found that by using gas fuel in a calcination kiln to reduce the generation amount of CO₂, the temperature near the tip part of the kiln burner increases as compared to in case of using carbon-containing thermal energy source such as petroleum, coal, etc., which lead to heat damage of the kiln burner. Therefore, they found out that by not using gas fuel in a calcination kiln, but by using gas fuel as a thermal gas energy source of a precalcination furnace having a lower treating temperature than a calcination kiln, the above object can be solved. The present invention has been thus completed.

Specifically, the present invention is as follows.

[1] A method for producing a cement clinker comprising using a thermal energy source comprising gas fuel as a thermal energy source of a precalcination burner, in a precalcination furnace in which a cement clinker powder raw material is precalinated.

[2] The method for producing a cement clinker according to [1], wherein the temperature of the precalcination furnace is 700 to 1000° C.

[3] The method for producing a cement clinker according to [1] or [2], wherein the gas fuel is hydrogen.

[4] The method for producing a cement clinker according to any one of [1] to [3], wherein the precalcination furnace comprises two or more precalcination burners.

[5] A method for producing a cement, comprising a finishing step of mixing gypsum to the cement clinker produced by the method for producing a cement clinker according to any one of [1] to [4], and crushing the cement clinker mixed with the gypsum.

### Advantageous Effects of Invention

According to the method for producing cement clinker of the present invention, the generation amount of CO₂ can be reduced without affecting usual operation.

### BRIEF DESCRIPTION OF DRAWING

FIG. 1 is a figure showing one example of the steps of the method for producing a cement clinker of the present invention.

FIG. 2 is a figure showing one example of the production equipment of cement clinker of the present invention.

FIG. 3 is a figure showing one example of the steps of the method for producing a cement clinker of the present invention.

### DESCRIPTION OF EMBODIMENTS

The method for producing a cement clinker of the present invention is characterized by using a thermal energy source comprising gas fuel as a thermal energy source of a precalcination burner, in a precalcination furnace in which a cement clinker powder raw material is precalcinated.

Since the method of producing cement clinker of the present invention utilizes gas fuel as a part of thermal energy source of a precalcination burner, the generation amount of CO₂ can be reduced as compared to in case of using only carbon-containing thermal energy source such as petroleum, coal, etc. On the other hand, when using gas fuel in the calcination kiln, since the burning speed of gas fuel is faster as compared to carbon-containing thermal energy source such as petroleum, coal, etc. the temperature near the tip part of the kiln burner increases and the kiln burner may be heat damaged. However, in the present invention, since it is used in a precalcination furnace having a low treatment temperature, it is possible to suppress heat damage of the burner, to perform operation as conventional.

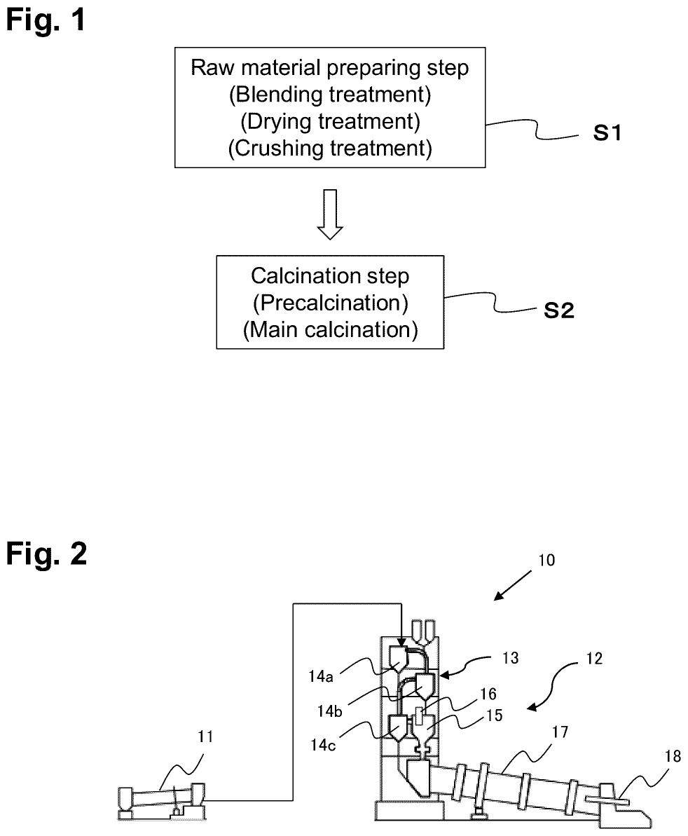

Here, FIG. 1 is a figure showing one example of the steps of the method for producing a cement clinker of the present invention. The production method of the present invention comprises generally a raw material preparing step and a calcination step. Each step is explained in detail in the following.

### (Raw Material Preparing Step)

Raw material preparing step is a step of drying and crushing cement clinker raw material to prepare powder raw material (step 1). Here, as cement clinker raw material, conventionally well-known common cement clinker raw materials such as limestone, clay, silica stone can be used.

In the raw material preparing step, mainly, blending treatment, drying treatment and crushing treatment are performed. Blending treatment is a treatment of blending each cement clinker raw material at a predetermined proportion according to the purpose. Drying treatment is a treatment of heat drying the cement clinker raw material by each raw material, or in a blended (mixed) state. Crushing treatment is a treatment of crushing dried cement clinker raw material, and can be performed at the same time as the drying treatment. Dyring treatment can be performed before the crushing treatment and/or at the same time as the crushing treatment.

In the drying treatment of the raw material preparing step, thermal energy of combustion gas generated in the calcination step can be used.

### (Calcination Step)

The calcination step comprises a precalcination step of precalcinating a cement clinker powder raw material prepared in the above-mentioned raw material preparing step in a precalcination furnace, and a calcination step for main calcination of the cement clinker powder raw material which has been precalcinated in the precalcination step (step 2).

As thermal energy source of the calcination step, generally carbon-containing thermal energy source such as petroleum, coal, etc. is used, while in the present invention, gas fuel is used as a part or all of the thermal energy source of a precalcination burner in a precalcination furnace. Examples of gas fuel include hydrogen, methane, ethane, propane, ammonia, etc., while in the point of calcination quality and that it does not at all generate CO₂, hydrogen is preferred. By using gas fuel as a part of thermal energy source, CO₂ generation by calcination can be reduced.

Specifically, for the used amount of gas fuel of a precalcination burner, it can be 1 to 100% of the total thermal energy source on calorie basis, and there is no problem to be 50% or more, 70% or more, and 90% or more.

The temperature of the precalcination furnace is for example 700 to 1000° C., preferably 800 to 900° C. Therefore, even by using gas fuel as thermal energy source of the precalcination furnace, there is almost no increase in load to the burner and gas fuel can be efficiently used. Further, since the temperature inside the furnace of the calcination kiln is a very high temperature, such as 1600 to 2000° C., by using gas fuel in the calcination kiln, the temperature of the kiln burner increases, and the kiln burner may be heat damaged.

Further, it is preferable that the precalcination furnace comprises two or more burners, more preferably three or more, further preferably four or more, and particularly preferably five or more burners. By providing two or more burners, since the heat quantity per burner can be small, even in case of using gas fuel, heat damage of the burner can be prevented by suppressing the load to each burner.

In the following, the production equipment that can practice the method for producing a cement clinker of the present invention is explained. FIG. 2 is a figure showing one example of the production equipment of cement clinker of the present invention.

As shown in FIG. 2, the production equipment 10 of cement clinker of one embodiment of the present invention comprises a crushing apparatus 11 that dries and crushes cement clinker raw material, and a calcination apparatus 12 that calcinates the crushed cement clinker raw material.

Crushing apparatus 11 introduces combustion gas generated in the calcination apparatus 12, and performs crushing treatment while drying cement clinker raw material.

Calcination apparatus 12 comprises a preheater part 13 that preliminarily heats the injected cement clinker powder raw material. The preheater part 13 is provided with a plurality of cyclones 14a-14c, and precalcination furnace 15. The precalcination furnace 15 is provided with a plurality of precalcination burner 16. Further, next to the precalcination furnace 15, a rotary kiln 17 that performs calcination of cement clinker raw material is provided. On the exit side of the rotary 17, one kiln burner 18 is provided.

The cement clinker powder raw material injected in the calcination apparatus 12 is calcinated while moving the preheater part 13 and the rotary kiln 17, to generate cement clinker.

In the present invention, as thermal energy source of the precalcination burner 16 of the precalcination furnace 15, gas fuel is used in place of a part or all of the carbon-containing thermal energy source such as petroleum, coal, etc. Thereby, generation of CO₂ can be suppressed. Further, the temperature in the precalcination furnace 15 is lower than the rotary kiln 16 which performs the main calcination, and in the precalcination furnace 15, a plurality of burners 16 is provided, and since the heat quantity per burner can be small, even in case of using gas fuel, the burner 16 is not heated more than expected and there is no heat damage to the burner 16.

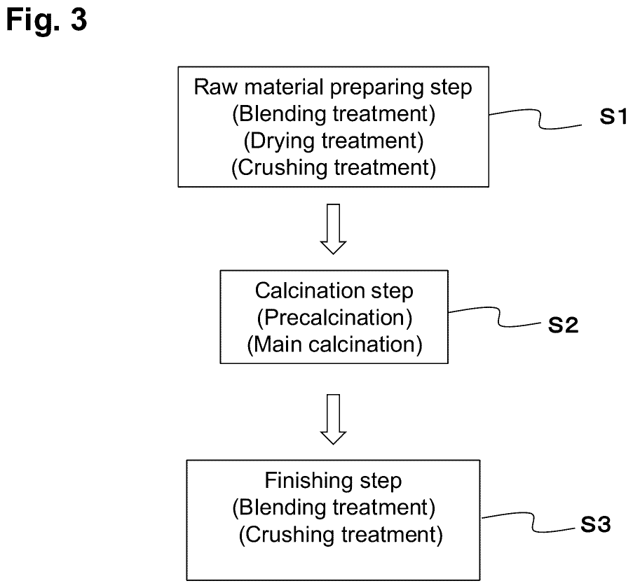

Further, the method for producing cement of the present invention is characterized by comprising a finishing step of mixing gypsum to the cement clinker produced by the above-mentioned production method, and crushing the cement clinker mixed with the gypsum. Here, FIG. 3 is a figure showing one example of the steps of the method for producing cement of the present invention.

### (Finishing Step)

In the finishing step, at least gypsum is mixed to the cement clinker prepared in steps 1 and 2 and the cement clinker mixed with the gypsum is crushed, to produce cement (step 3). In the present step, to the cement clinker or the cement mixed with gypsum, other materials such as blast furnace slug or fly ash, etc. can be mixed according to need.

### EXAMPLES

In the following, the Example of the present invention is shown, while the technical scope of the present invention is not limited to this.

Fluid simulation of the gas temperature near the burner tip part was performed for a case where in the precalcination furnace, hydrogen was used as thermal energy source, and the number of precalcination burners was 3, 4, and 5. Further, as comparison, fluid simulation of the gas temperature near the burner tip part was performed for a case of hydrogen mono-combustion in the kiln burner.

These fluid simulation conditions are shown in Table 1 and the results are shown in Table 2. In this fluid simulation, the precalcination furnace and kiln structure are defined as 2D axis symmetry, and the solution was obtained by applying turbulence model, radiation model, and calcination model. The present fluid simulation was performed by using a widely-used fluid simulation software, Ansys Fluent 2021, manufactured by Ansys.

TABLE 1

| | Burner hydrogen | | Burner primary air | | Burner secondary air | | Kiln bottom gas | |
|---|---|---|---|---|---|---|---|---|
| | Nm3/h · burner | ° C. | Nm3/h · burner | ° C. | Nm3/h | ° C. | Nm3/h | ° C. |
| 1 kiln burner | 29000 | 30 | 12000 | 30 | 65000 | 840 | — | — |
| 3 precalcination | 8550 | 30 | 3600 | 30 | 23060 | 770 | 45901 | 556 |
| furnace burners | | | | | | | | |
| 4 precalcination | 6413 | 30 | 2700 | 30 | 17295 | 770 | 34425 | 556 |
| furnace burners | | | | | | | | |
| 5 precalcination | 5130 | 30 | 2160 | 30 | 13836 | 770 | 27540 | 556 |
| furnace burners | | | | | | | | |

TABLE 2

| | Burner tip part |
|---|---|
| | Gas temperature (° C.) |
| 1 kiln burner | 615 |
| 3 precalcination furnace burners | 271 |
| 4 precalcination furnace burners | 241 |
| 5 precalcination furnace burners | 233 |

As shown in Table 2, the gas temperature at the tip part of the precalcination burner is lower as compared to the kiln burner, and it can be seen that larger is the number of precalcination burner, the gas temperature of each precalcination burner is low, and the load is small.

### INDUSTRIAL APPLICABILITY

Since the production method of cement clinker of the present invention is useful as a method and equipment for producing cement clinker, it is industrially applicable.

### REFERENCE SIGNS LIST

10 production equipment of cement clinker
11 crushing apparatus
12 calcination apparatus
13 preheater part
14 cyclone
15 precalcination furnace
16 precalcination burner
17 rotary kiln
18 kiln burner

1. A method for producing a cement clinker comprising using a thermal energy source comprising gas fuel as a thermal energy source of a precalcination burner, in a precalcination furnace in which a cement clinker powder raw material is precalinated.

2. The method for producing a cement clinker according to claim 1, wherein the temperature of the precalcination furnace is 700 to 1000° C.

3. The method for producing a cement clinker according to claim 1, wherein the gas fuel is hydrogen.

4. The method for producing a cement clinker according to claim 1, wherein the precalcination furnace comprises two or more precalcination burners.

5. A method for producing a cement, comprising a finishing step of mixing gypsum to the cement clinker produced by the method for producing a cement clinker according to claim 1, and crushing the cement clinker mixed with the gypsum.

6. The method for producing a cement clinker according to claim 2, wherein the gas fuel is hydrogen.

7. The method for producing a cement clinker according to claim 2, wherein the precalcination furnace comprises two or more precalcination burners.

8. The method for producing a cement clinker according to claim 3, wherein the precalcination furnace comprises two or more precalcination burners.

9. The method for producing a cement clinker according to claim 6, wherein the precalcination furnace comprises two or more precalcination burners.

10. A method for producing a cement, comprising:
mixing gypsum to the cement clinker produced by the method for producing a cement clinker according to claim 2, and
crushing the cement clinker mixed with the gypsum.

11. A method for producing a cement, comprising:
mixing gypsum to the cement clinker produced by the method for producing a cement clinker according to claim 3, and
crushing the cement clinker mixed with the gypsum.

12. A method for producing a cement, comprising:
mixing gypsum to the cement clinker produced by the method for producing a cement clinker according to claim 4, and
crushing the cement clinker mixed with the gypsum.

13. A method for producing a cement, comprising:
mixing gypsum to the cement clinker produced by the method for producing a cement clinker according to claim 6, and
crushing the cement clinker mixed with the gypsum.

14. A method for producing a cement, comprising:
mixing gypsum to the cement clinker produced by the method for producing a cement clinker according to claim 7, and
crushing the cement clinker mixed with the gypsum.

15. A method for producing a cement, comprising:
mixing gypsum to the cement clinker produced by the method for producing a cement clinker according to claim 8, and
crushing the cement clinker mixed with the gypsum.

16. A method for producing a cement, comprising:
mixing gypsum to the cement clinker produced by the method for producing a cement clinker according to claim 9, and
crushing the cement clinker mixed with the gypsum.
